(19) United States
(12) Patent Application Publication
(10) Pub. No.: US 2009/0084111 A1
(43) Pub. Date: Apr. 2, 2009

(54) TURBOMACHINE NOZZLE COWL HAVING JET NOISE REDUCTION PATTERNS

(75) Inventors: Sebastien Jean-Paul AEBERLI, Paris (FR); Pierre Philippe Marie Loheac, Brie Comte Robert (FR); Stephane Jacques Francois Thomas, Coubert (FR); Alexandre Alfred Gaston Vuillemin, Fontainebleau (FR); Kamel Zeggai, Bondy (FR)

Correspondence Address: OBLON, SPIVAK, MCCLELLAND MAIER & NEUSTADT, P.C., 1940 DUKE STREET, ALEXANDRIA, VA, 22314, US

(73) Assignee: SNECMA, Paris (FR)

(21) Appl. No.: 12/210,533

(22) Filed: Sep. 15, 2008

(30) Foreign Application Priority Data
Sep. 28, 2007 (FR) 07 57940

(51) Int. Cl. F02K 1/44; F01N 1/08; F01N 1/14

(52) U.S. Cl. 60/770; 181/213; 181/220; 181/259

(57) ABSTRACT

The invention relates to a cowl for a turbomachine nozzle, the cowl including a plurality of repetitive patterns disposed to extend a trailing edge of said cowl and spaced circumferentially apart from one another. Each pattern is in the form of a quadrilateral having a base that is formed by a portion of the trailing edge of the cowl and two vertices that are spaced downstream from the base and that are connected thereto via two sides, each side having the shape of a parabola. Each pattern is asymmetrical relative to a midplane of the pattern containing a longitudinal axis of said cowl, and it comprises a first portion inclined radially towards the inside of the cowl, and a second portion inclined radially towards the outside of the cowl.

### BACKGROUND OF THE INVENTION

The present invention relates to the general field of nozzles fitted to turbomachines. More particularly, it relates to a separate-stream nozzle in which at least one of the cowls is provided with patterns for the purpose of reducing the jet noise generated at the outlet from the nozzle.

In general, a separate-stream nozzle for a turbomachine comprises a primary cowl, a secondary cowl disposed concentrically around the primary cowl so as to define a first annular channel for passing the flow of an outer stream (or cold stream), and a central body disposed concentrically inside of the primary cowl so as to define a second annular channel for passing the flow of an inner stream (or hot stream).

One known technique for reducing jet noise at the outlet from such a nozzle is to encourage mixing between the hot and cold streams coming from the turbomachine. The nub of the problem lies in controlling the characteristics of the mixing that is to be obtained between the hot and the cold streams, it being understood that one of the consequences of mixing too roughly is an undesirable increase in the amount of turbulence in the near field of the exhaust. Such an increase has a negative influence on any potential for reducing noise that might be obtained in mixing zones that are further away. Thus, the mixing between the streams needs to be as effective as possible, while nevertheless complying with aerodynamic and acoustic constraints and efficiency criteria.

To this end, it is well known to provide one of the cowls of the nozzle with a plurality of repetitive patterns that are distributed around the entire circumference of the trailing edge of the cowl. By putting such patterns into place at the trailing edge of the nozzle cowl, mixing is achieved between the streams by creating contrarotating longitudinal turbulence (or vortices).

The example, in European patent application EP 0 913 567 provides for the trailing edge of the primary cowl of the nozzle to have a plurality of repetitive patterns of triangular shape (or “chevrons”) that serve to encourage mixing between the hot and cold streams. Similarly, publication GB 2 355 766 proposes fitting the trailing edges of the primary and secondary cowls of the nozzle with a plurality of repetitive patterns of trapzoidal shape (or “tabs”).

Although the above-mentioned patterns do indeed encourage mixing between the streams, they nevertheless present drawbacks. Patterns at the trailing edge of at least one of the cowls of the nozzle and that are symmetrical in shape (regardless of whether they are triangular or in the form of tabs) give rise, in the vicinity of each pattern, the two contrarotating longitudinal vortices of equivalent intensity that are relatively close to each other. Around the entire circumference of the nozzle cowl, that amounts to a plurality of pairs of vortices that compensate mutually. This gives rise to mixing between the streams that is not very effective, in particular in zones that are further away from the exhaust.

Publication EP 1 617 068 discloses patterns each in the form of a quadrilateral having a first portion that is inclined radially towards the inside of the cowl and a second portion that is inclined radially towards the Outside of the cowl. In the vicinity of each of those patterns, the intensities of the two vortices that are generated are different, such that the vortices do not compensate over the entire circumference of the cowl. That results in the flow further away from the exhaust zone being set into overall rotation, with the consequences of achieving mixing between the streams that is more effective and of achieving better jet noise reduction, in particular at low frequencies. However, in addition to such patterns obtaining acoustic improvement at low frequencies, they also give rise to an increase in noise levels at high frequencies.

### OBJECT AND SUMMARY OF THE INVENTION

The present invention seeks to remedy the above-mentioned drawbacks by providing a cowl for a separate-stream nozzle, which cowl enables mixing between the hot and cold streams to be made more effective so as to reduce the jet noise at the outlet from the nozzle, both at high frequencies and at low frequencies.

The this end, the invention provides an annular cowl for a turbomachine nozzle, the cowl having a plurality of repetitive patterns extending a trailing edge of said cowl and spaced circumferentially apart from one another, each pattern being substantially in the shape of a quadrilateral having a base formed by a portion of the trailing edge of the cowl, and two vertices spaced downstream from the base and connected thereto via two sides, each pattern being asymmetrical relative to a midplane of the pattern containing a longitudinal axis of said cowl and comprising a first portion that is inclined radially towards the inside of the cowl and a second portion that is inclined radially towards the outside of the cowl, wherein the sides of each pattern are substantially parabolic in shape.

Compared with the patterns disclosed in publication EP 1 617 068, the patterns of the invention provide in particular for a connection to the trailing edge of the cowl via profiles of that are of parabolic shape. In publication EP 1 617 068, the sides of the patterns are straight-line segments with the connections between two adjacent patterns being circular. The applicant has found about the parabolic shape of the sides of the patterns make it possible to obtain mixing that is less “rough” and thus to obtain an acoustic penalty at high frequencies that is of smaller size, or even nonexistent. Furthermore, the asymmetry of the patterns enables the jet to be destructured in the near field of the exhaust, and thus contributes more effectively to reducing jet noise.

In a particular disposition, the first portion of each pattern extends longitudinally over a distance that is greater than the distance over which the second portion of said pattern extends longitudinally.

The inclination distance of the first portion of each pattern is preferably greater than the inclination distance of the second portion of said pattern, in such a manner that the penetration into the inner stream is greater than the penetration into the outer stream.

The inclination distance of the first portion of each pattern may lie in the range 0% to 30% of the distance over which said portion extends longitudinally, and the inclination distance of the second portion may lie in the range 0% to 20% of the distance over which said portion extends longitudinally.

Preferably, the first portion of each pattern extends longitudinally over a distance lying in the range 0.4 to 0.6 times the circumferential distance between two adjacent patterns, and the second portion extends longitudinally over a distance lying in the range 0.2 to 0.4 times said circumferential distance between two adjacent patterns.

The patterns may be placed at the trailing edge of one of the cowls of the nozzle, while being symmetrical about a vertical plane containing an axis perpendicular to the longitudinal axis of the nozzle.

The present invention also provides a turbomachine nozzle in which the primary cowl and/or the secondary cowl is a cowl as defined above.

The present invention also provides a turbomachine including a nozzle as defined above.

### BRIEF DESCRIPTION OF THE DRAWINGS

Other characteristics and advantages of the present invention appear from the following description made with reference to the accompanying drawings that show embodiments having no limiting character. In the figures:

FIG. 1 is a perspective view of a turbomachine nozzle fitted with a cowl constituting an embodiment of the invention;

FIG. 2 is an enlarged view of a jet noise reduction pattern fitted to the nozzle of FIG. 1;

FIG. 3 is a face view of the FIG. 2 noise-reduction pattern;

FIG. 4 is a perspective view of a turbomachine nozzle fitted with a cowl constituting another embodiment of the invention;

FIG. 5 is a face view of a turbomachine nozzle constituting yet another embodiment of the invention; and

FIG. 6 plots jet noise attenuation curves for nozzle cowls provided with patterns.

### DETAILED DESCRIPTION OF EMBODIMENTS

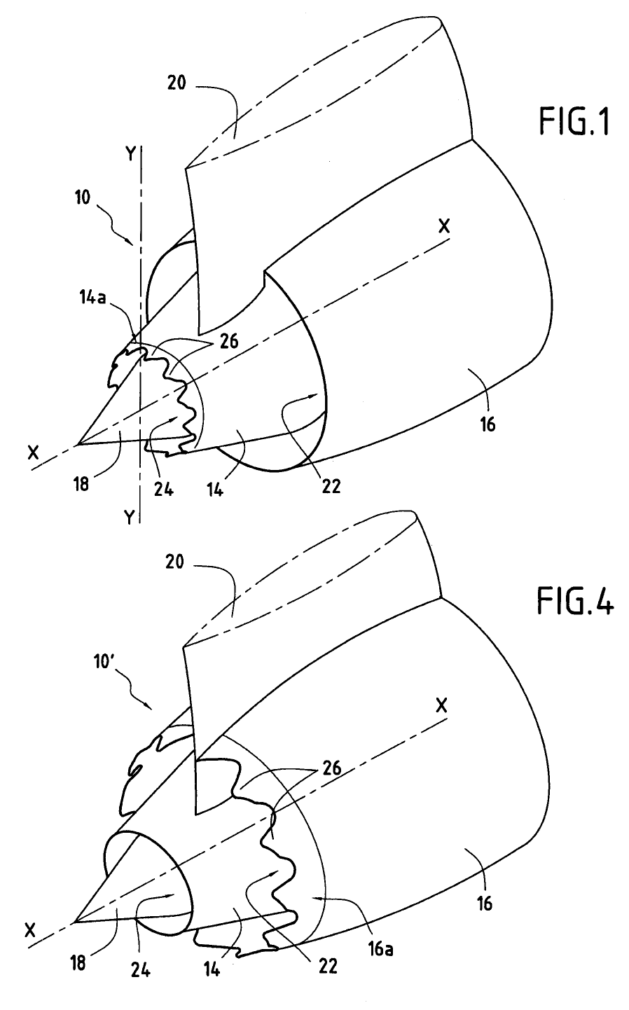

FIG. 1 is a perspective view of a separated stream nozzle 10 of a turbomachine. The nozzle 10 is of axially-symmetrical shape about its longitudinal axis X-X, and it is typically formed by a primary cowl 14, a secondary cowl 16, and a central body 18 centered on the longitudinal axis X-X of the nozzle.

The primary cowl 14 is of substantially cylindrical or frustoconical shape, and it extends around the longitudinal axis X-X of the nozzle. The central body 18 is disposed concentrically inside of the primary cowl 14 and it is terminated by a portion that is substantially conical.

The secondary cowl 16 is likewise of substantially cylindrical or frustoconical shape and it surrounds the primary cowl 14 concentrically, extending around the longitudinal axis X-X of the nozzle.

It should be observed that the longitudinal axis X-X of the nozzle coincides with the longitudinal axes of the primary and secondary cowls 14 and 16.

The separated-stream nozzle as defined above is fastened under an airplane wing (not shown in figures) by means of a support pylon 20 bearing against the secondary cowl 16 of the nozzle and extending inside the secondary cowl as far as the primary cowl 14.

The concentric assembly of the elements of the nozzle 10 serves to define: firstly, between the primary and secondary cowls 14 and 16, a first annular channel 22 for passing the flow of air coming from the turbomachine (also referred to as the secondary stream or the cold stream); and secondly between the primary cowl 14 and the central body 18, a second annular channel 24 for passing the flow of an internal stream of gas coming from the turbomachine (also referred to as the primary stream or the hot stream).

The inner and outer streams of gas in these two annular channels 22 and 24 mix together at the trailing edge 14a of the primary cowl 14.

In FIG. 1, it should be observed that the central body 18 of the nozzle 10 is of the external type, i.e. the central body 18 extends longitudinally beyond the trailing edge 14a of the primary cowl 14.

Nevertheless, the invention can also be applied to a nozzle of the internal type in which the trailing edge of the primary cowl extends longitudinally beyond the central body so as to cover the central body completely.

At least one of the cowls 14 and 16 of the nozzle 10 (in FIG. 1, this is the primary cowl 14) includes a plurality of repetitive patterns 26 for the purpose of reducing jet noise at the outlet from the nozzle. These patterns 26 extend from the trailing edge 14a of the primary cowl and they are regularly spaced apart from one another in a circumferential direction.

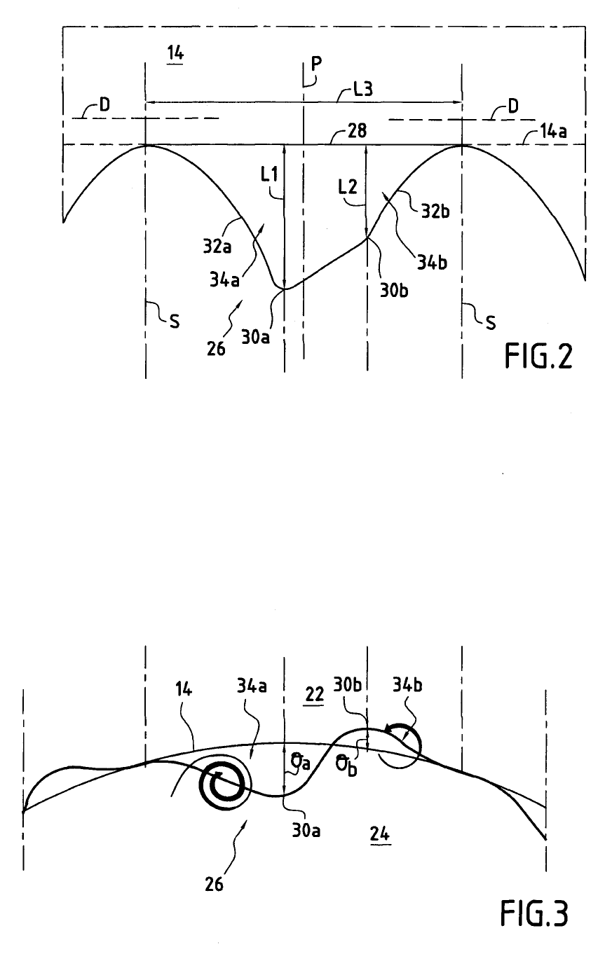

As shown in FIG. 2, each pattern 26 is in the form of a quadrilateral having a base 28 formed by a portion of the trailing edge 14a of the primary cowl and two vertices 30a and 30b spaced downstream from the base and connected thereto by two sides 32a and 32b.

Furthermore, each pattern 26 is asymmetrical relative to a radial plane P that contains the longitudinal axis X-X and that cuts the pattern in half. In addition, each pattern 26 has a first portion 34a that is inclined radially towards the inside of the primary cowl 14, and a second portion 34b that is inclined radially towards the outside of the primary cowl 14.

These particular characteristics of the jet noise reduction patterns 26 are shown in FIGS. 2 and 3.

In particular, the plane P shown in FIG. 2 corresponds to the midplane of the jet noise reduction pattern 26, the plane P containing the longitudinal axis X-X (not shown in this figure). Relative to the plane P, the shape of the pattern 26 is asymmetrical.

The midplane P divides the pattern 26 into its two portions: the first portion 34a that is inclined radially towards the inside of the primary cowl 14 (i.e. into the inner stream); and the second portion 34b that is inclined radially towards the outside of the cowl 14 (i.e. into the outer stream).

According to the invention, each of the sides 32a and 32b of each pattern 26 is substantially in the shape of a parabola having a directrix D that extends in a tangential direction, and an axis of symmetry S that extends in a longitudinal direction (see FIG. 2).

In other words, the patterns 26 are connected to the trailing edge 14a of the primary cowl 14 via profiles that are substantially parabolic.

In a rectangular frame of reference defined by the directrix D and the axis of symmetry S, the sides 32a and 32b of each pattern 26 are thus defined by an equation of the type y=k.x² (where y is defined along the axis S, x is defined along the axis D, and k is a constant), the constant k advantageously lying in the range 0 to 1 (and is preferably equal to 0.4).

According to an advantageous characteristic of the invention, the first portion 34a of each pattern 26 extends longitudinally over a distance L1 that is greater than the distance L2 over which the second portion 34b of the pattern extends longitudinally (where the distances L1 and L2 correspond to the distance between each of the vertices 30a and 30b respectively and the base 28 of the patterns). With such a configuration, the penetration of the pattern 26 into the inner stream is greater than its penetration into the outer stream.

Furthermore, the first portion 34a of each pattern 26 extends longitudinally over a distance L1 that preferably lies in the range 0.4 to 0.6 times the circumferential distance L3 between two adjacent patterns (the distance L3 corresponds to the length of the base 28 of the quadrilateral forming the pattern 26).

Similarly, the second portion 34b of each pattern 26 extends longitudinally over a distance L2 that preferably lies in the range 0.2 to 0.4 times the distance L3 between two adjacent patterns.

The respective radial inclinations of the first and second portions 34a and 34b of the jet noise reduction patterns 26 are shown in FIG. 3.

In this figure, the end of the first portion 34a of the pattern is inclined radially towards the inside of the cowl 14, i.e. towards the inner stream flow channel 24, by an inclination distance θa (in other words, the vertex 30a of the pattern is spaced apart from the trailing edge 14a of the cowl 14 by a distance θa).

The end of the second portion 34b of the pattern is inclined radially towards the outside of the cowl 14, i.e. towards the outer stream flow channel 22 by an inclination distance θb (in other words the vertex 30b of the pattern is spaced apart from the trailing edge 14a of the cowl 14 by a distance θb).

According to another advantageous characteristic of the invention, the inner penetration distance θa of the first portion 34a of each jet noise reduction pattern 26 is greater than the outer penetration distance θb of the second portion 34b of the pattern. With such a configuration, the penetration of the pattern 26 into the inner stream is greater than its penetration into the outer stream.

As an indication, the inner penetration distance θa of the first portion 34a of the pattern may represent 0% to 30% of the longitudinal distance L1 over which this portion of the pattern extends. Similarly, and still as an example, the outer penetration distance θb of the second portion 34b of the pattern may correspond to 0% to 20% of the longitudinal distance L2 over which this second portion extends.

Still with reference to FIG. 3, it can clearly be seen about the particular shape of the noise-reduction patterns 26 of the nozzle of the invention serves to generate, in the vicinity of each pattern, turbulence in the form of two longitudinal vortices that are contrarotating and of different intensities. The intensities of these two vortices therefore do not compensate.

As a result, over the entire cowl provided at its trailing edge with these noise-reduction patterns, the flow in the zone is furthest away from the exhaust is caused to rotate overall, and this is favorable to achieving more effective mixing between the inner and outer streams.

FIG. 4 shows a turbomachine nozzle 10′ constituting another embodiment of the invention.

In this embodiment, the jet noise reduction patterns 26 of the nozzle 10′ are no longer disposed on the primary cowl 14, but rather on the trailing edge 16a of the secondary cowl 16.

In this configuration, the patterns 26 serve to encourage mixing between: firstly the cold stream of gas flowing in the first channel 22 defined by the primary and secondary cowls 14 and 16 of the nozzle 10′; and secondly the stream of air flowing along the outer wall of the secondary cowl 16.

The particular shape and disposition of these jet noise reduction patterns 26 are entirely identical to those of the description made with reference to FIGS. 1 to 3.

In FIG. 4, it should be observed that the jet noise reduction patterns 26 are not disposed around the entire circumference of the trailing edge of the secondary cowl. A gap without any pattern is provided in the region where the nozzle 10′ connects with the support pylon 20 so as to enable the pylon to be fastened thereto.

As shown in FIG. 5, in yet another embodiment of the invention the noise reduction patterns may be placed on the trailing edge of one of the cowls of the nozzle (in FIG. 5 this is the primary cowl 14), in a manner that is symmetrical about a vertical plane P′ containing an axis Y-Y perpendicular to the longitudinal axis X-X. The plane of symmetry P′ is defined on the top portion of the cowl by the support pylon 20, and on the bottom portion thereof by a particular shape for the pattern 26, where this shape may, for example, be the result of assembling together two half-patterns.

In yet another embodiment of the invention (not shown the figures), the jet noise reduction patterns may be provided both on the primary cowl and on the secondary cowl of the nozzle.

In general, it should be observed that the shape and the number of jet noise reduction patterns provided on the circumference of the trailing edge of the cowl (primary cowl or secondary cowl) may vary. In particular, the angular positions of their asymmetrical shapes relative to the midplane P, the characteristic lengths L1 and L2 of their two portions, and the extents to which they penetrate into the inner and outer streams can differ depending on the application.

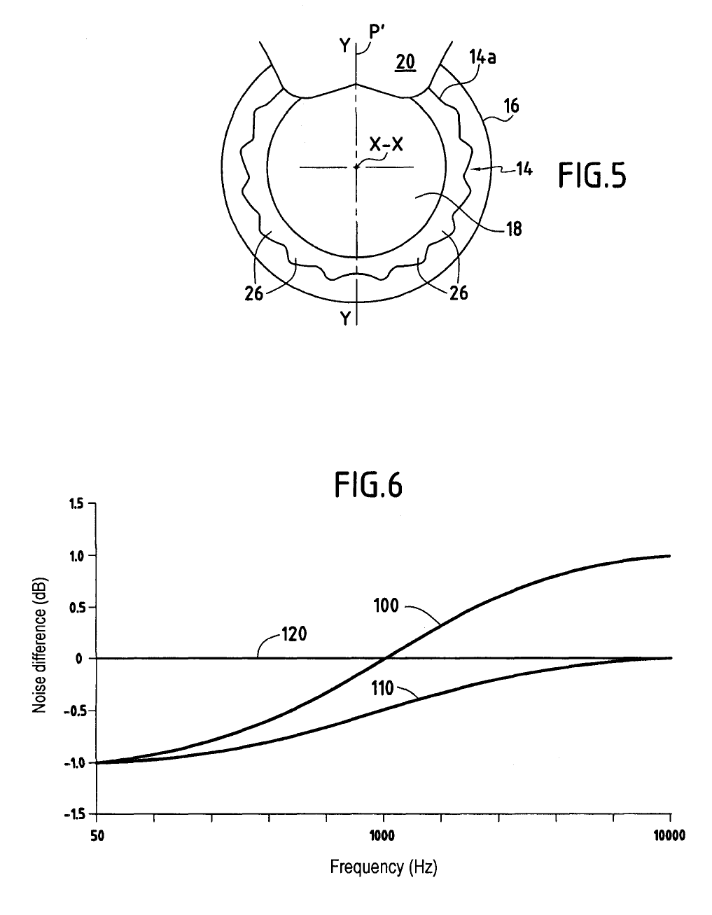

Numerical simulations have been performed concerning the level of noise generated by a separate-stream nozzle in which the primary cowl is fitted with noise reduction patterns of the invention. The results of these simulations are plotted in the comparative graph of FIG. 6.

The graph in this figure plots curves showing the noise differences in decibels (dB) as a function of frequency for a nozzle having its primary cowl provided with noise reduction patterns of shape corresponding to the teaching of European patent application EP 1 617 068 (curve 100), and for a nozzle in which the primary cowl is provided with noise-reduction patterns of the invention (curve 110). The noise differences are calculated relative to a curve 120 corresponding to the noise generated by a separate-stream nozzle in which the primary cowl does not have any noise reduction patterns.

The Applicant has thus found that using noise-reduction patterns of the invention makes it possible not only to reduce the low-frequency noise (frequency lower than about 1000 hertz (Hz)) compared with a nozzle not having any patterns (curve 120), but also to reduce high-frequency noise (frequency higher than about 1000 Hz) compared with the nozzle in which the primary cowl is provided with patterns in accordance with publication EP 1 617 068 (i.e. straight-sided patterns connected to the trailing edge of the cowl via circular profiles).

In other words, compared with the nozzle described in publication EP 1 617 068, the nozzle of the present invention makes it possible to limit to a very great extent the increase in jet noise at high frequencies, while conserving the improvements obtained at low frequencies.

What is claimed is:

1. An annular cowl for a turbomachine nozzle, the cowl having a plurality of repetitive patterns extending a trailing edge of said cowl and spaced circumferentially apart from one another, each pattern being substantially in the shape of a quadrilateral having a base formed by a portion of the trailing edge of the cowl, and two vertices spaced downstream from the base and connected thereto via two sides, each pattern being asymmetrical relative to a midplane of the pattern containing a longitudinal axis of said cowl and comprising a first portion that is inclined radially towards the inside of the cowl and a second portion that is inclined radially towards the outside of the cowl, wherein the sides of each pattern are substantially parabolic in shape.

2. A cowl according to claim 1, wherein the first portion of each pattern extends longitudinally over a distance that is greater than the distance over which the second portion of said pattern extends longitudinally.

3. A cowl according to claim 1, wherein the inclination distance of the first portion of each pattern is greater than the inclination distance of the second portion of said pattern.

4. A cowl according to claim 1, wherein the inclination distance of the first portion of each pattern lies in the range 0% to 30% of the distance over which said portion extends longitudinally, and the inclination distance of the second portion lies in the range 0% to 20% of the distance over which said portion extends longitudinally.

5. A cowl according to claim 1, wherein the first portion of each pattern extends longitudinally over a distance lying in the range 0.4 to 0.6 times the circumferential distance between two adjacent patterns, and wherein the second portion extends longitudinally over a distance lying in the range 0.2 to 0.4 times said circumferential distance between two adjacent patterns.

6. A cowl according to claim 1, wherein the patterns are disposed symmetrically relative to a plane containing an axis perpendicular to the longitudinal axis of the cowl.

7. A turbomachine nozzle comprising a primary cowl disposed around a longitudinal axis of the nozzle and a secondary cowl disposed concentrically around the primary cowl, wherein the primary cowl is a cowl according to claim 1.

8. A turbomachine nozzle comprising a primary cowl disposed around a longitudinal axis of the nozzle and a secondary cowl disposed concentrically around at the primary cowl, wherein the secondary cowl is a cowl according to claim 1.

9. A turbomachine nozzle comprising a primary cowl disposed around a longitudinal axis of the nozzle and a secondary cowl disposed concentrically around the primary cowl, wherein the primary and secondary cowls are cowls according to claim 1.

10. A turbomachine including a nozzle according to claim 7.

11. A turbomachine including a nozzle according to claim 8.

12. A turbomachine including a nozzle according to claim 9.
